(19) United States
(12) Patent Application Publication
(10) Pub. No.: US 2009/0183650 A1
(43) Pub. Date: Jul. 23, 2009

(54) OPTIMIZATION OF CARBON COATINGS

(75) Inventors: Marca M. Doeff, Hayward, CA (US); James D. Wilcox, Berkeley, CA (US); Robert Kostecki, Lafayette, CA (US); Grace Y. Lau, Fremont, CA (US)

Correspondence Address: LAWRENCE BERKELEY NATIONAL LABORATORY, Technology Transfer & Intellectual Propery Managem, One Cyolotron Road MS 56A-120, BERKELEY, CA, 94720, US

(73) Assignee: The Regents of the University of California, Oakland, CA (US)

(21) Appl. No.: 12/302,476

(22) PCT Filed: Jun. 12, 2007
(86) PCT No.: PCT/US07/71054

§ 371 Date: Nov. 25, 2008

Related U.S. Application Data
(60) Provisional application No. 60/804,560, filed on Jun. 12, 2006.

(51) Int. Cl. C09D 1/00; B05D 5/12

(52) U.S. Cl. 106/286.2; 427/122; 106/286.8

(57) ABSTRACT

Several synthetic additives have been used to improve the carbon coatings on LiFePO4 electrode materials. Pyromellitic acid (PA) added prior to calcination decreases the D/G ratios of the carbon produced in situ, while the use of both iron nitrate and PA results in increased sp² character. Thus, the carbon coatings are structured with a greater fraction of graphitic character. The production of structured carbon coatings results in higher pressed pellet conductivities of LiFePO₄/C composites and improved electrochemical performance of cells containing these cathode materials, although the carbon content is not necessarily increased. The combination of both ferrocene and PA used during LiFePO₄ synthesis causes more carbon to be retained, although the structural characteristics are similar to that produced from the same amount of PA alone.

### CROSS-REFERENCE TO RELATED APPLICATIONS

This application claims priority to PCT Application PCT/US2007/071054, filed Jun. 12, 2007, which in turn claims priority to U.S. Provisional Patent Application 60/804,560, filed Jun. 12, 2006, both of which are incorporated by reference herein.

### STATEMENT OF GOVERNMENTAL SUPPORT

The invention described and claimed herein was made in part utilizing funds supplied by the U.S. Department of Energy under Contract No. DE-AC02-05CH11231 and in part utilizing funds provided by DARPA grant HR0011-04-1-0029. The Government has certain rights in this invention.

### TECHNICAL FIELD

This invention relates generally to formation of non-amorphous carbon films, and, more specifically, to methods for forming structured carbon films on electrode material particles and the composite materials that result therefrom.

### BACKGROUND OF THE INVENTION

In 11997, LiFePO₄ (triphylite) was introduced as a possible cathode for rechargeable Li-ion batteries. The abundant availability of Fe at a relatively low price and the good environmental compatibility make this an attractive alternative to currently used LiCoO₂ or LiMn₂O₄ cathodes. LiFePO₄ has a flat voltage plateau at about 3.4 V against Li and a theoretical capacity of 170 mAh/g. The practical discharge capacity of LiFePO₄ electrodes, however, is often much lower than the theoretical value, especially when high current densities are used. This has been attributed to low mobility of Li ions across the FePO₄/LiFePO₄ interface and a low electronic conductivity of ˜10⁻⁹ S/cm.

LiFePO₄ is of interest as a cathode material for Li-ion batteries intended for large-scale applications such as hybrid electric vehicles (HEVs) because of its potential for low cost and improved safety. To fulfill this promise, however, the power capability of this material needs to be improved. A factor limiting the performance of LiFePO4 is its low electronic conductivity, calculated to be about 10⁻⁹ S/cm at room temperature.

Several approaches have been used to address the rate limitations of LiFePO₄ electrodes. One of the more promising of these involves producing very small particles and coating them with conductive carbon. For example, a capacity of 160 mAh/g at C rate during cycling at 80° C. for a sample with 1 wt. % carbon coating has been reported. A strong correlation between particle size and performance has also been reported. The best performing materials were synthesized below 600° C., where particle growth is inhibited. Capacities of 120 mAh/g at 5C rate were recently reported for carbon-coated LiFePO₄ with particle sizes ranging from 100-200 nm.

It has been shown that carbon-coating LiFePO₄ particles results in greatly improved room-temperature electrochemical performance. One of the most promising avenues is the addition of conductive carbon either postsynthesis (e.g., by cogrinding) or by cofiring with organic or polymeric additives to produce coated particles. It is useful to keep the amount of carbon low in order to avoid decreasing the energy density unduly. An interesting observation is that electrode performance does not always track with the amount of carbon in LiFePO₄/C composites. The structure of the carbon, particularly the sp²/sp³ and disordered/graphene (D/G) ratios, strongly influences the electronic conductivity of the electrode. Samples containing smaller amounts of high quality carbon (i.e., those having high sp²/sp³ and low D/G ratios) can outperform those containing larger amounts of less conductive carbon. It has also been shown that the structure of the carbon in the composites produced by cofiring depends upon the source (i.e., type of organic or polymeric precursor) as well as the processing conditions. Careful attention to the carbon structure may make it possible to optimize an electrode by using a minimum amount of carbon while maximizing the conductivity of the LiFePO₄ composite. Other useful cathode materials include LiFePO₄, LiNi_{1/3}Co_{1/3}Mn_{1/3}O₂, LiCoO₂, LiNiO₂, LiNi_{0.8}Co_{0.2}O₂, and LiNi_{0.8}Co_{0.15}Al_{0.05}O₂.

Higher electronic conductivity scales with lower D/G ratios and increased sp²/sp³ ratios in carbon. There is a correlation between the structure of carbon in LiFePO₄ samples and the utilization upon discharge in lithium cells at room temperature. Significantly, some materials with low amounts of carbon and low D/G ratios outperformed those with more carbon having a more disordered structure. While optimizing the carbon structure may be key to obtaining good performance, it is difficult to produce highly structured (graphitic) coatings at the relatively low temperatures (600-800° C.) used for synthesis of LiFePO₄. Thus there is a need for methods and materials to produce structured carbon coatings at temperatures low enough to use with LiFePO₄ without risk of degrading the LiFePO₄. Such structured carbon coatings would be useful also in a number of other applications.

### SUMMARY OF THE INVENTION

The electrochemical performance of LiFePO₄ can be greatly enhanced when the structure of the in situ carbon covering the particles is improved. As disclosed in the embodiments of the invention herein, a method is provided for achieving this improvement whereby small amounts of pyromellitic acid and a graphitization catalyst such as iron nitrate, ferrocene or a derivative thereof are added during processing. The overall carbon content of the resulting product, though still below 2 wt %, has a higher graphene content and the hydrogen to carbon (H/C) ratio is reduced compared to materials prepared without the additives. Optimization of the carbon structure makes it possible to maximize the conductivity of LiFePO₄ particles with a minimum amount of carbon.

### BRIEF DESCRIPTION OF THE DRAWINGS

The figures are for illustrative purposes only and are not drawn to scale.

FIG. 1 is a scanning electron micrograph of a typical LiFePO₄— carbon composite.

FIG. 2 shows Raman spectra of LiFePO₄ samples processed with and without additives as indicated.

FIG. 3 is a plot of specific capacities as a function of discharge rate for lithium cells containing three different samples of LiFePO₄.

FIG. 4 is a plot showing conductivity as a function of temperature for several LiFePO₄/C pressed pellet materials.

FIG. 5 is a plot showing specific capacities obtained at various discharge rates for lithium cells containing LiFePO₄ samples prepared with and without PA (left axis), and D/G ratios as determined by Raman microprobe spectroscopy for the same samples (light axis).

FIG. 6 is a plot of specific capacities as a function of discharge rate for lithium cells containing three different samples of LiFePO₄.

FIG. 7 is a plot of specific capacities as a function of discharge rate for lithium cells containing LiFePO₄ samples processed with ferrocene or FCA, with or without PA.

FIG. 8 is a plot of pressed pellet conductivities as a function of sp²/sp³ ratio for two different sets of composite LiFePO₄ samples having similar carbon contents.

### DETAILED DESCRIPTION OF THE INVENTION

The low temperatures (typically ˜600-750° C.) used in the preparation of LiFePO₄ have presented a challenge for the co-production of well-ordered, graphitic carbon in-situ. Nevertheless, as will be disclosed herein, it is possible to manipulate the synthesis conditions to produce carbons with desirable characteristics. In particular, the judicious selection of carbon sources and graphitization catalysts can result in markedly improved coatings.

LiFePO₄ may be prepared by a number of different routes, including hydrothermal synthesis, carbothermal reduction, sol-gel, or aqueous precipitation routes, microwave processing, and solid-state synthesis under an inert or reducing atmosphere. Samples made from precursors with organic moieties (oxalates, acetates, etc.) or processed in plastic containers typically contain small amounts of residual (in situ) carbon from pyrolysis of the organics or polymers.

The amount of residual carbon present in samples varies in complex ways with the furnace conditions; some is lost as CO or CO₂ during carbothelimal reduction, particularly if Fe(III) species are present. Near or above 800° C., these processes may result in the formation of iron carbide, iron phosphocarbides and/or iron phosphides from reaction with LiFePO₄ itself. Nevertheless, the presence of carbon or carbonaceous materials during synthesis is beneficial as grain growth is inhibited and oxidation of iron by adventitious oxygen is slowed or prevented.

In one exemplary embodiment, samples were prepared as follows: LiFePO₄ powder was produced using a sol-gel method starting from Fe(NO₃)₃.9H₂O (Sigma Aldrich, 98+%), C₂H₃O₂Li.2H₂O (Sigma Aldrich), and H₃PO₄ (EMP). Precursors were dissolved in water in a stoichiometric ratio of 1:1:1 and then combined with two stoichiometric equivalents of HOCH₂CO₂H (glycolic acid, Sigma Aldrich, 70% solution in water). The pH was adjusted to between 8.5 and 9.5 using NH₄OH (EMD) and the water evaporated on a hot plate. The sample was then calcined at 500° C. for 10 hours under a flow of nitrogen before being planetary ball milled with 6 wt. % C₆H₂(CO₂H) (pyromellitic acid, Sigma Aldrich) and 1 wt. % ferrocene (Alfa Aesar, recrystallized) for 1 hour in acetone. The solvent was then evaporated and the resulting powder fired to 600° C. under flowing nitrogen for an additional 10 hours. Further details on synthesizing LiFePO₄ can be found in the publications, M. M. Doeff, Y. Hu, F. McLarnon, and R. Kostecki, Electrochem. and Sol. State Lett. 6 (2003) A207-A209 and Y. Hu, M. M. Doeff, R. Kostecki, and R. Fifiones, J. Electrochem. Soc., 151 (2004) A1279-1285, both of which are included by reference herein.

Up to 8 wt. % pyromellitic acid (C₆H₂(CO₂H)₄, Sigma Aldrich, abbreviated PA from this point forward) and some or all of iron nitrate, ferrocene (C₁₀H₁₀Fe, Alfa Aesar, recrystallized), and ferrocenecarboxylic acid (C₁₁H₁₀O₂Fe, Aldrich, 97%, abbreviated FCA from this point forward), ranging from 0.001-1 wt % were added to various samples. The mixtures were ground using a planetary ball mill in an appropriate solvent (ethanol or acetone) for one hour. The grinding solvent was then evaporated under a flow of nitrogen and the resulting powder was thoroughly mixed and fired to 600° C. for ten hours.

Phase purity was determined by X-ray diffraction (XRD) on the resulting powders using a Philips X'Pert diffractometer using an X'Celerator detector with Cu Kα radiation (λ=1.54 Å). Particle size distributions were resolved by means of a Beckman Coulter particle size analyzer (model LS 230) using Darvan*C (ammonium polymethacrylate, aqueous solution, R.T. Vanderbilt Company Inc.) as a dispersant. Particle morphology studies were conducted using a field emission-scanning electron microscope (FE-SEM, Jeol JSM-6340F). Luvak Inc. (Boylston, Mass.) was used to conduct the elemental analyses (carbon and hydrogen) of several samples, reported as H/C ratios in Table I.

An integrated confocal Raman microscope system, “Labram,” made by ISA Group Horiba was used to analyze the structure of the active materials. Raman spectroscopy measurements were carried out at room temperature in ambient atmosphere using an internal He—Ne 632 nm 10 mW laser as the excitation source. The power of the laser beam was adjusted to 0.1 mW with neutral filters of various optical densities. The size of the laser beam at the sample was ˜1.2 μm, and the average acquisition time for each spectrum was 25 seconds. The resolution of this instrument is approximately 1.7 cm⁻¹. Baseline correction and deconvolution analysis of Raman spectra were performed with a commercial software package (PeakFit, version 4.05, SPSS Inc.).

Pressed pellets for conductivity studies were fabricated by uni-axially pressing 0.5 g of active material to 10 kpsi in a 0.5 inch (1.27 cm) stainless steel die. The pellets were then transferred into balloon holders and cold isostatically pressed to 180 kpsi achieving a final density of 70% of the theoretical LiFePO₄ density (3.6 g/cm³). Thin gold electrodes were then sputtered on to each face of the pellet using a Bal-Tec SCD 050 sputter coater. AC impedance spectra were obtained using a Solartron Instruments 1260 impedance/gain-phase analyzer at selected temperatures between 25 and 200° C. Conductivities were derived from the intercepts of the capacitative arcs with the z′-axes in the Nyquist plots.

Electrode samples were formed from 80 wt % active material, 8 wt % Kynar poly(vinylidene fluoride) (PVDF) (Elf Atochem North America Inc., Technical Polymers Department), 6 wt % SFG-6 synthetic flake graphite (Timcal Ltd., Graphites and Technologies), and 6 wt % acetylene black. This fabrication process has been described previously in M. M. Doeff, Y. Hu, F. McLamon, and R. Kostecki, Electrochem. and Sol. State Lett. 6, A207 (2003), which is included by reference herein. Electrodes were cast as a slurry in 1-methyl-2-pyrrolidinone (Sigma Aldrich, 99%) onto aluminum current collectors and dried for 24 hours in air followed by 12-24 hours in a vacuum oven at 120° C. Cathodes with an area of 1.8 cm² were punched from the cast electrode and typically had loadings of about 1 mAh/cm². Assembly of lithium half-cells in 2032 coin cells was performed in a helium filled glove box using 1 M LiPF₆ in 1:2 ethylene carbonate/dimethylcarbonate (EC/DMC) electrolyte solution and a Celgard 3401 separator. At least two cells of the same type were tested for each material to ensure reproducibility. Electrochemical studies were undertaken galvanostatically using an Arbin BT/HSP-2043 and/or a Macpile II (Bio-Logic, S.A., Claix, France) automated cycling data recorder between 2.0 and 3.9 V at room temperature. Cells were charged at a current density corresponding to C/25 and allowed to rest 15 minutes between half-cycles.

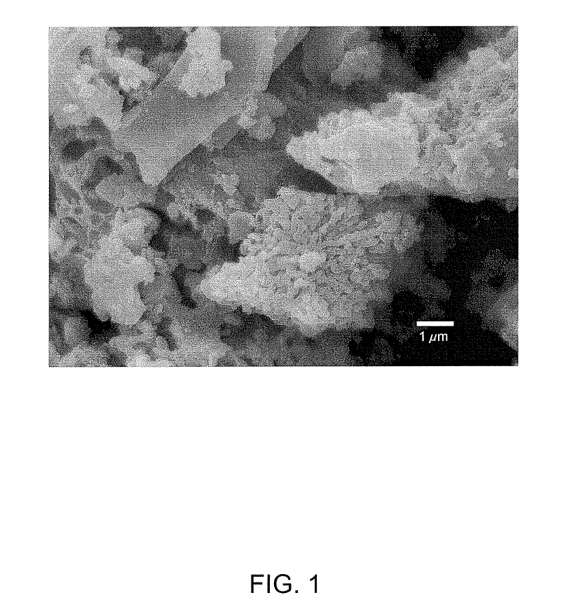

All powders were determined to be phase-pure by XRD analysis. The primary particle sizes found in the powders of all samples were highly variable, ranging from less than 100 nm to more than 1 μm, as can be seen in the SEM image in FIG. 1. Agglomerates were larger than 2 μm in all cases, with large, bimodal size distributions observed in both the particle size and SEM studies. Individual particle morphologies varied widely as well, ranging from large smooth platelets to highly porous particles, which formed due to gas evolution during synthesis.

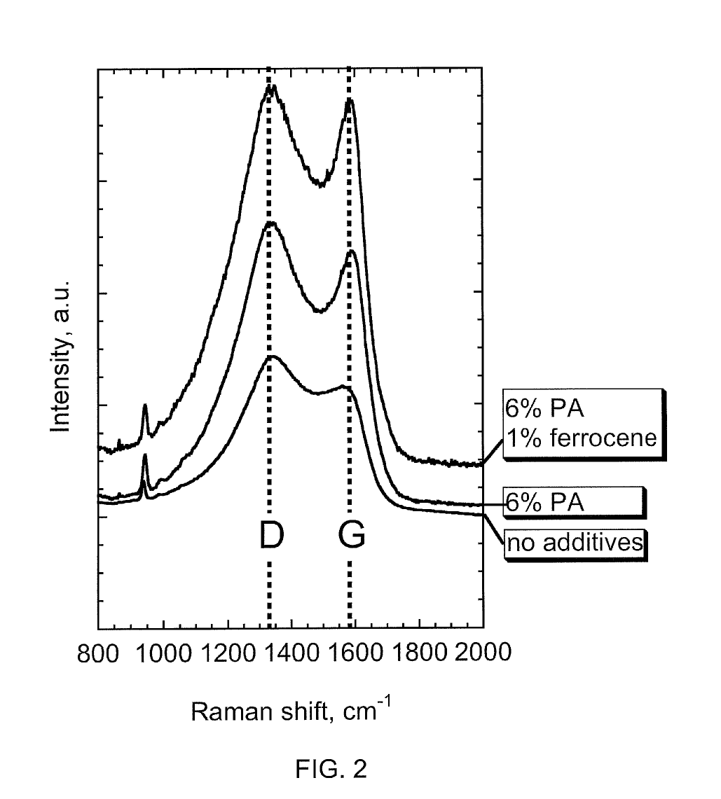

Raman spectroscopy is a particularly useful tool for characterizing the near-surface structure (i.e. disorder and crystallite formation) of carbon films because carbon is a relatively strong scatterer with two E_{2g} modes predicted to be Raman active. FIG. 2 shows Raman spectra of LiFePO₄ samples processed with and without additives as indicated. The D and G bands of in situ carbon are marked. The band at 942 cm⁻¹ corresponds to the symmetric vibration of the PO₄ group in LiFePO₄.

It is a common practice to use polymeric or organic additives as carbon sources during synthesis of carbon coated LiFePO₄. Some organic or polymeric precursors do not decompose completely at the low synthesis temperatures used to make LiFePO₄. Residual hydrogen and functional groups on carbon lower the electronic conductivity, resulting in electrode materials with poor electrochemical performance. Raman spectra and C, H, and N elemental analyses of LiFePO₄ powders processed with poly(acrylonitrile), perylenetetracarboxylicdianhydride or other well-known graphite precursors, show that these additives do not decompose sufficiently at the relatively low synthesis temperatures (˜700-800° C.) to form a carbon coating with good conductivity. In some cases, the addition of the precursors actually results in electrode materials with electrochemical performance inferior to that of samples processed without additives. In contrast, pyromellitic acid (PA) decomposes readily, as evidenced by lower H/C ratios in the

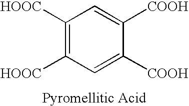

resulting products when compared to those processed with the above-mentioned additives. The quality of the carbon for samples processed with PA also improves over that for those synthesized with no additives, as can be seen by the increased sharpness and intensity of the G-band in the Raman spectrum of the former (compare middle and bottom spectra in FIG. 2). The relative peak heights and widths of carbon bands change substantially with the pyrolysis temperature and the nature of the precursor materials. The variation of the width and intensity of the D and G bands is related to the growth and size of different carbon phases, the presence of functional groups and impurities.

Table I shows carbon contents, H/C ratios, D/G and sp²/sp³ ratios for selected LiFePO₄ samples processed with pyromellitic acid (PA), both with or without graphitization catalysts.

TABLE I

| Wt. % | | | | Average D/G | |
|---|---|---|---|---|---|
| PA | Catalyst | % C | H/C | (S.D.)^{a} | sp²/sp³ (S.D.)^{a} |
| 0 | — | 0.304 | 0.079 | 1.26 (0.013) | 0.091 (0.0298) |
| 2 | — | 0.423 | 0.048 | 1.19 (0.029) | 0.120 (0.0996) |
| 4 | — | 0.714 | 0.045 | 1.12 (0.005) | 0.257 (0.004) |
| 6 | — | 0.764 | 0.054 | 1.10 (0.059) | 0.271 (0.061) |
| 8 | — | 0.843 | 0.037 | 1.11 (0.243) | 0.243 (0.016) |
| 6 | 0.001 wt. % | 0.711 | 0.056 | 1.11 (0.018) | 0.319 (0.011) |
| | Fe(NO₃)₃ | | | | |
| 6 | 0.01 wt. % | 0.594 | 0.056 | 1.06 (0.052) | 0.309 (0.091) |
| | Fe(NO₃)₃ | | | | |
| 0 | 1 wt % | 0.551 | 0.039 | 1.98 (0.056) | 0.0067 (0.0049) |
| | ferrocene | | | | |
| 6 | 1 wt. % | 1.45 | 0.044 | 1.09 (0.040) | 0.183 (0.053) |
| | errocene | | | | |
| 6 | 1 wt. % FCA^{c} | 1.56 | 0.028 | 1.11 (0.009) | 0.204 (0.009) |

^{a}S.D. = standard deviation.

As shown in Table I, the overall carbon content in the final products generally increases somewhat as more PA is used, although this is very dependent upon the furnace conditions. H/C ratios also rise, particularly above 8 wt %, indicating that complete decomposition becomes more difficult for large amounts of PA. The addition of PA during synthesis results in a modest increase in the carbon content and a general decrease in the H/C ratio with some sample variation, close to that of PA itself (0.05). The latter indicates the degree of decomposition of the organic components in the synthesis mixture, and suggests that better quality carbons are produced from the additive, due, in part, to its lower hydrogen content. Also included in Table 1 are carbon structural parameters determined from analysis of the Raman spectra obtained on the various LiFePO₄ samples.

It should be noted that the D/G (disordered/graphene) and sp²/sp³ ratios determined by analysis of the Raman spectra and shown in Table I do not yield the actual ratios but rather values that can be correlated to these structural parameters. Thus, the ratios are useful for comparing samples to each other but not as quantitative measures of the graphene or sp³ contents. Based on this analysis, the data in Table I show that D/G ratios decrease and sp²/sp3 ratios increase as more PA is added, up to about 6 wt. %. Thus, the structure of carbon produced when PA is present during calcination is markedly different from that produced from the precursors alone.

It is well known that some iron compounds can catalyze the formation of graphite at relatively low temperatures. Graphite may precipitate upon decomposition of Fe₃C (cementite) near 650° C. during the production of cast iron, in a process known as “dusting”. Furthermore, carbon nanotubes, which consist of curled graphene sheets, can be made at temperatures as low as 600-700° C. using organic or polymeric carbon sources and iron compounds as promoters.

These observations explain the variability in the in situ carbon structure found in LiFePO₄ samples processed similarly, since iron oxides are common surface impurities. Anything more than trace oxidation of LiFePO₄ samples during synthesis is clearly undesirable, severely limiting the options for producing graphitic carbon this way. Instead, addition of small amounts of graphitization catalysts such as iron nitrate, ferrocene, or ferrocene derivatives along with PA during LiFePO₄ synthesis can be used to improve the carbon structure, as shown in FIG. 2. When iron nitrate is added, there is no increase in the amount of in situ carbon but H/C ratios are lowered and the rate behavior is improved to a limited degree.

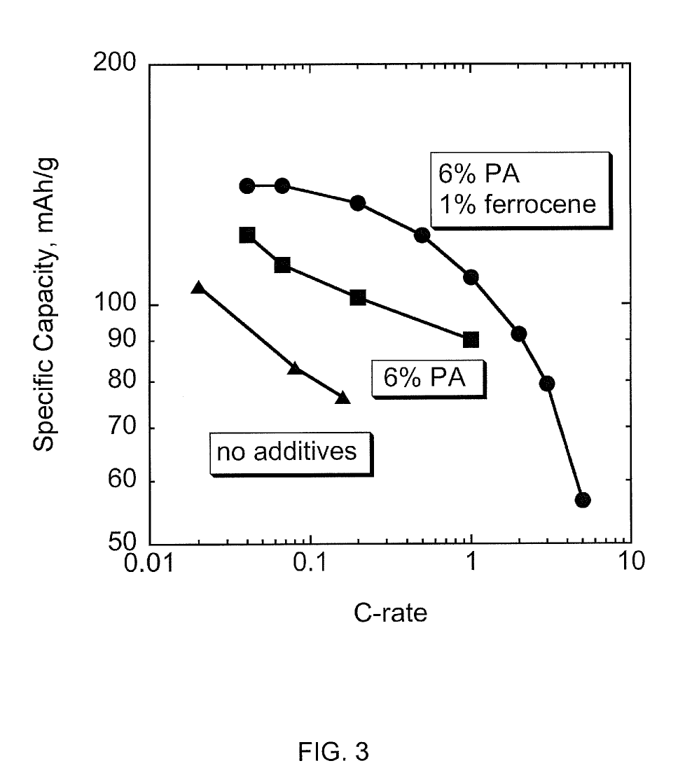

FIG. 3 is a plot of rate capabilities of electrodes containing LiFePO₄ samples processed with and without additives as indicated, in lithium cells at room temperature. In situ carbon contents are 0.7% for the sample processed with no additives, 0.76% for the sample processed with 6% PA, and 1.45% for the sample processed with 6% PA and 1% ferrocene. Addition of ferrocene results in both an overall increase in carbon content and a much lower H/C ratio. Pressed pellet conductivities, as measured by AC impedance, increase, and rate capability is improved dramatically. These effects seem to be attributable to carbon structure, as particle size and morphology are not significantly changed by the addition of the iron-containing species. As shown in FIG. 3, addition of ferrocene results in both an overall increase in carbon content and a much lower H/C ratio. Pressed pellet conductivities, as measured by AC impedance, increase, and rate capability is improved dramatically. Again these effects can be attributed to carbon structure, as particle size and morphology are not significantly changed by the addition of the iron-containing species.

The structure of the in situ carbon influences the electrochemical behavior of LiFePO₄ samples. Electrode utilization rises as D/G ratios and the amorphous carbon content decreases (i.e., the electronic conductivity increases). The observation that some samples with low carbon contents outperform those with larger amounts of poor-quality carbon is significant, and suggests that the amount of coating necessary to ensure good high-rate performance can be minimized provided that the structure is optimized. A considerable challenge is the temperature limitation (<750-800° C.) imposed by LiFePO₄ synthesis conditions. For example, the graphene content and electronic conductivity are low for carbons prepared from polymeric precursors at temperatures below about 700° C., but increase dramatically above this temperature. However, the considerable variations found in the in situ carbon of LiFePO₄ samples suggest that much can be done to manipulate the structure, even considering the temperature constraints.

In one embodiment, good rate behavior is obtained when LiFePO₄ is processed with approximately 4-8 wt % PA, which yields materials with in situ carbon content below 1 wt %. In another embodiment, good rate behavior is obtained when LiFePO₄ is processed with approximately 1-10 wt % PA. In another embodiment, good rate behavior is obtained when LiFePO₄ is processed with approximately 1-20 wt % PA. There is a correlation between pressed pellet conductivities measured by AC impedance and the rate performance, but not necessarily with the amount of carbon. Secondary particles in these samples have a lava rock-like appearance, and size distributions are wide. Processing with PA does not appear to change the primary carbon particle size (˜200 nm) significantly, indicating that the observed rate effects are indeed due to the improved C structure.

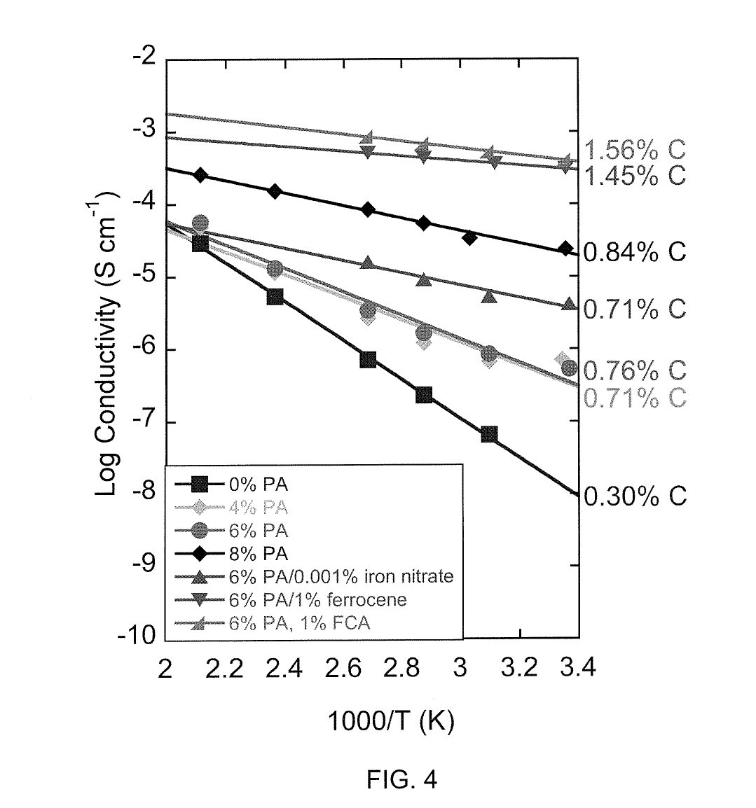

FIG. 4 is a graph that shows pressed pellet conductivities as a function of temperature for several LiFePO₄/C materials. The room temperature conductivity of ˜10⁻⁸ S/cm extrapolated from the Arrhenius fit for the LiFePO₄ powder produced without PA agrees well with data previously obtained on pure LiFePO₄ powders, despite the presence of 0.3% residual carbon from reaction precursors. Samples prepared with 4 or 6 wt. % PA have room temperature conductivities nearly two orders of magnitude higher, although the carbon contents are increased to only about 0.7 wt. %. Further improvements are observed when 8% PA is used.

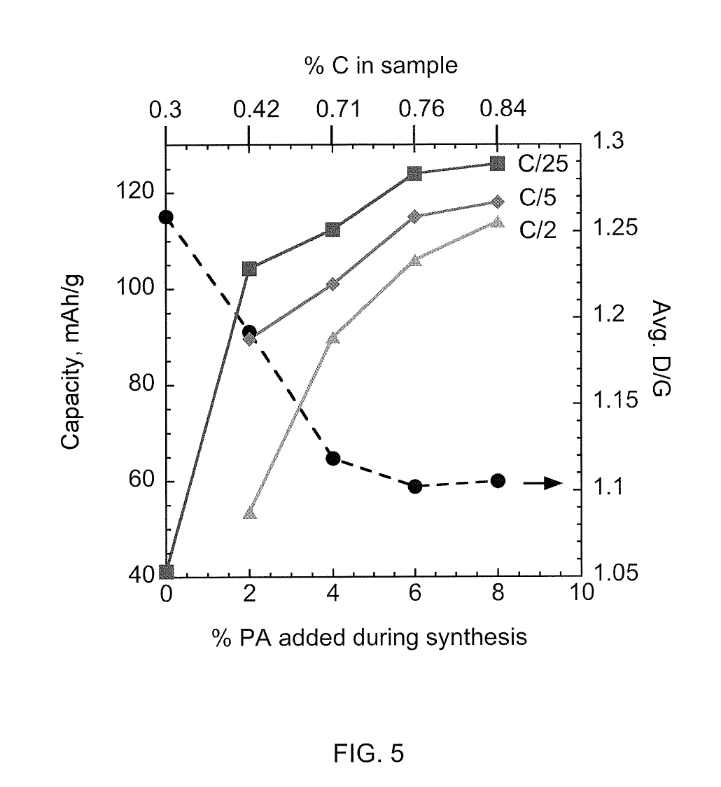

FIG. 5 shows capacities obtained at several discharge rates for lithium cells containing materials processed with PA and their corresponding D/G ratios. The carbon structural parameters and pressed pellet conductivities correlate well with electrochemical performance. The structure of the carbon affects the conductivity of the composite material, which also influences the rate behavior in electrochemical cells. Thus, the latter tends to track the former. The differences seen in the conductivities and electrochemical characteristics of the samples prepared with larger amounts of PA show primarily the influence of increasing the carbon content, as the carbon structure does not vary significantly. Material processed with 6 wt. % PA and having 0.76 wt. % C has a capacity of 120 mAh/g.

The improvement in carbon structure, pressed pellet conductivities and electrochemical performance seen in samples prepared with PA is striking, rate limitations are still evident. Optimum performance may still be achieved with further improvements in the carbon structure and/or increases in the carbon content.

In an exemplary embodiment, samples calcined with small amounts of iron nitrate (0.001-0.01 wt. %) and PA produced powders with C contents below 1 wt. %, similar to those calcined with PA alone (see Table I). The D/G ratios are not significantly changed from those of samples processed with similar amounts of PA, but the sp²/sp³ ratios are higher. This suggests that, while the graphene domain sizes are not changed from materials prepared with PA only, there is a greater proportion of carbon with a graphitic nature. It is possible to assess the effect of the increased sp² character on the electronic conductivity by comparing the results for two composites with identical carbon contents (0.71%), one processed with iron nitrate, and one without. As shown in FIG. 4, the sample processed with both iron nitrate and PA has higher conductivity that the sample processed with PA alone.

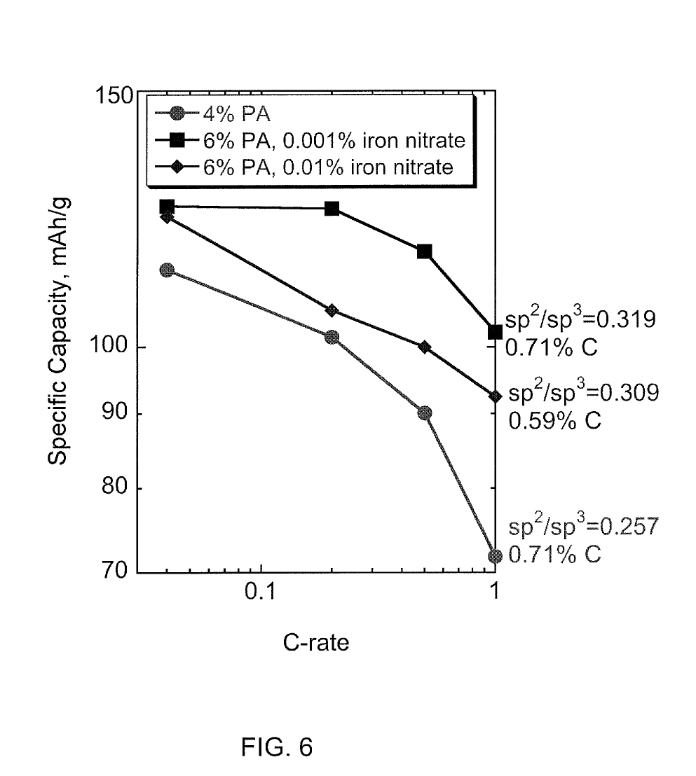

FIG. 6 is a plot of specific capacities as a function of discharge rate for lithium cells containing three different samples of LiFePO₄, one processed with 4% PA alone, one with 0.001 wt. % iron nitrate and 6 wt. % PA, and one with 8% PA and 0.01% iron nitrate. As shown in FIG. 6, the sample processed with both iron nitrate and PA has better electrochemical performance (specific capacity) than the sample processed with PA alone. The higher discharge capacities at given rates may be attributed to the increased composite conductivity (˜10⁻⁵ S/cm at room temperature) due to the higher sp²/sp³ ratio. The conductivity of the sample treated with both iron nitrate and PA exceeds that of all non-catalyst treated samples except the one made with 8 wt. % PA, which contains more carbon. Note also that the effect of a higher sp²/sp³ ratio can compensate for a lower carbon content in terms of electrochemical performance; in FIG. 6, a LiFePO₄ material containing only 0.59% C (processed with both PA and iron nitrate) is superior to the one containing 0.71% C, (processed with only PA) which has a lower sp²/sp³ ratio.

LiFePO₄ processed with PA and higher concentrations of iron nitrate performed worse than the materials made with 0.01% iron nitrate or less as shown in Table I. When iron nitrate (or the oxides that form from thermal decomposition thereof) is located in carbon-rich areas on the surfaces of the powders, graphitization can occur. But too much iron nitrate can result in an overabundance of resistive iron oxide, which can affect the electrochemical performance adversely. Conversely, carbon-rich areas not in contact with the catalyst tend not to graphitize at the relatively low temperatures used to synthesis LiFePO₄. A low concentration of iron nitrate is preferable to prevent excessive formation of iron oxide. Homogenous dispersion within the carbon source is useful in order to achieve maximum graphitization. For some materials processed with PA and iron nitrate, considerable spot-to-spot variations in the Raman spectra were observed, indicating that the quality of the carbon was not uniform throughout the powder. Consequently, such materials do not show any appreciable improvement in the electrochemical performance and are not considered further here.

Ferrocene and its derivatives have graphitization advantages over iron nitrate as they contain both catalyst centers and carbon sources within the same molecules, which helps to overcome difficulties in ensuring close contact between the two entities. They have been used extensively in the synthesis of nano-structured carbon materials, and as soot control agents for cleaner burning fuels. A composite prepared with 1 wt. % ferrocene, however, has a low carbon content (see Table I), only slightly higher than that of LiFePO₄ prepared without any additives. Ferrocene sublimes at about 175° C., so much of it is lost during calcination under the synthesis conditions described herein. The quality of the resulting carbon is poor, judging from the structural factors listed in Table I, although its thorough decomposition is evidenced by a low H/C ratio. In contrast, LiFePO₄ prepared with either ferrocene or FCA as well as PA has significantly higher carbon content than materials prepared with the same amount of PA alone (see Table I), although the final carbon content is still less than 2 wt. %. This suggests that an interaction between ferrocene and PA occurs upon heating, which results in improved retention of elemental carbon. The H/C ratios of these composites are lower than that of the starting materials, ferrocene (0.08) and FCA (0.075) themselves, indicating nearly complete thermal decomposition. The carbon structural factors, as determined by Raman spectroscopy, are similar to those of composites made with PA alone, although the sp²/sp³ ratios are less than that of the materials processed with iron nitrate. Thus, the several orders of magnitude increase in conductivity of a ferrocene/PA-treated LiFePO₄ pressed pellet compared to the others in FIG. 3, may be attributable mainly to the increase in carbon content, rather than to any improvements in carbon structure over composites made with PA alone.

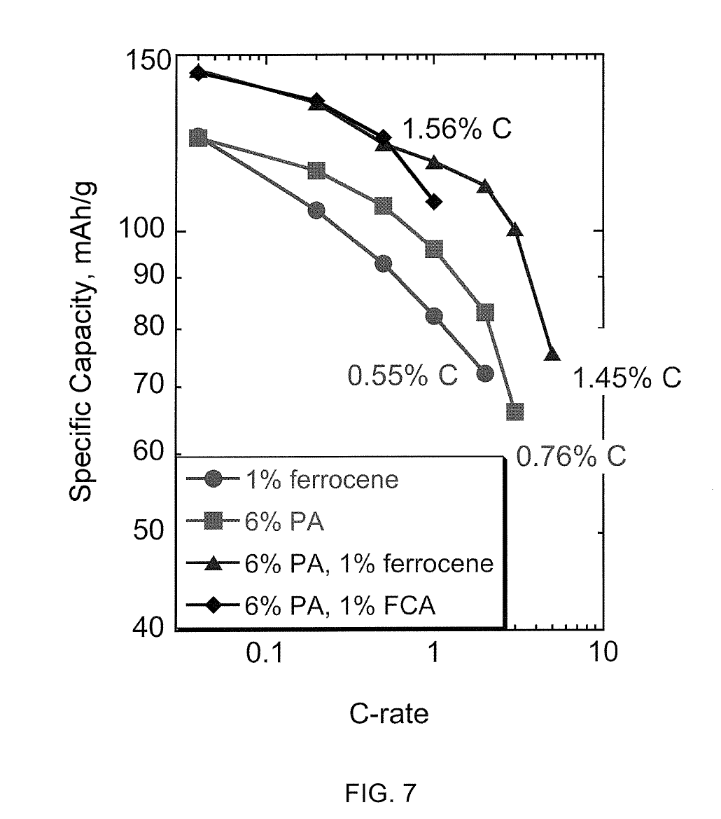

FIG. 7 shows the specific capacity as a function of current density for lithium cells containing LiFePO₄ cathodes treated with ferrocene or FCA and PA. Results for a cell containing material treated with ferrocene alone and another with PA alone are also included, for comparison. The best high rate behavior was obtained for cells containing LiFePO₄ processed with 1 wt. % ferrocene and 6 wt. % PA, in accordance with the high pressed pellet conductivities seen in FIG. 4. Because the structural characteristics of the carbon do not vary much for these samples (with the exception of the poorly performing material treated with ferrocene alone), the differences in the electrochemical performance shown in FIG. 6 can be attributed mainly to the changes in carbon content. The material containing 1.56% carbon (processed with FCA and PA), however, performs somewhat worse at C-rate than the one treated with ferrocene and PA, which has a marginally lower carbon content of 1.45% and slightly lower pressed pellet conductivities. As with some of the materials calcined with iron nitrate, considerable spot-to-spot variation was seen in the Raman spectra of the FCA-treated material, indicating non-homogeneity of the carbon coating. (The structural factors in Table I derived from these spectra are averages taken from 10 spectra). The non-homogeneity is less likely to have an impact on pressed pellet conductivities, in which a percolation threshold is easier to achieve, than in a porous composite electrode containing the same material, used to obtain the electrochemical data. In contrast, much better homogeneity in the Raman spectra was observed for materials processed with ferrocene. FCA does not sublime as ferrocene does, but undergoes a two-step thermal decomposition at 250° C. and 410° C. The volatility of ferrocene may be beneficial in that it promotes a more even distribution of carbon compared to FCA.

The results presented here show that the composite conductivity, and therefore, the electrochemical performance, is related to the amount, structure, and distribution of the carbon in the coatings on the LiFePO₄ particles. In some cases, composites containing less carbon are more conductive than those with more, due to a higher sp² character. This translates directly into improved electrochemical performance. The best results in this study, however, were obtained for composites with carbon contents above 1 wt. %. This may be due, in part, to the fact that it is easier to obtain complete coverage over particle surfaces when more carbon is present. Provided that a relatively homogeneous coating can be produced by, for example, better mixing prior to calcination, what is the lowest carbon content needed to produce a high-rate LiFePO₄? How much improvement in the carbon structure is necessary to allow a substantial decrease in the content? The pressed pellet conductivity data, although fairly limited, offers some insights into these questions.

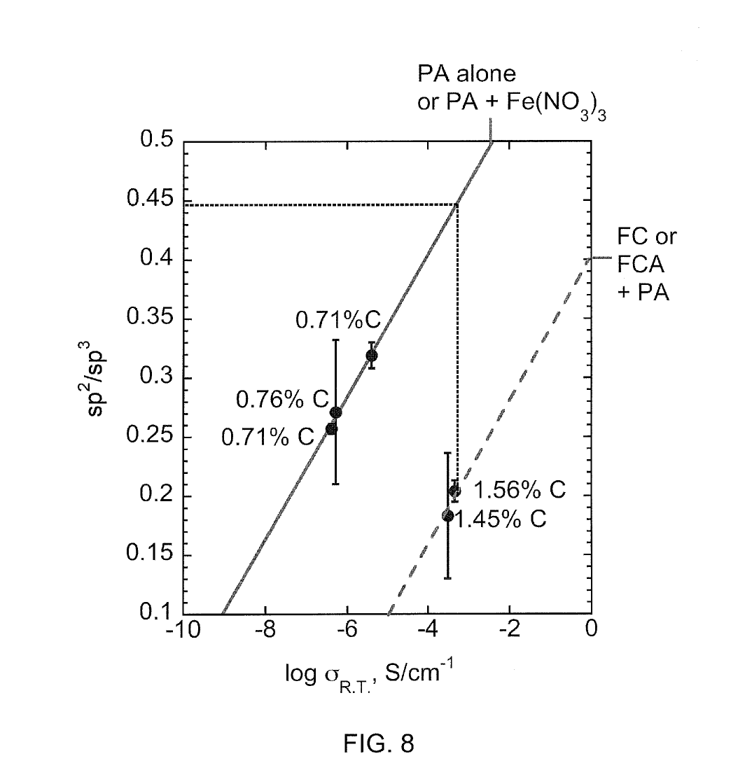

FIG. 8 is a plot of pressed pellet conductivities as a function of sp²/sp³ ratio for two different sets of composite LiFePO₄ samples having similar carbon contents. The solid gray line shows a linear fit to the data for composites with 0.71-0.76 wt. % carbon. The dashed gray line parallels this fit and connects the data for composites with higher carbon contents. Dotted black lines show the improvement needed in sp²/sp³ ratio in the low carbon samples to achieve conductivities similar to those found in the high carbon samples. FC=ferrocene and other abbreviations are as explained in the text. In FIG. 8, the logarithms of the room temperature pressed pellet conductivities of three samples with similar carbon contents (˜0.7 wt. %) are plotted vs. the sp²/sp³ ratios. D/G and H/C ratios of the carbons in these composites are fairly similar, so that the data mainly show the effect of increasing the sp² character. Data for two other materials with higher carbon contents (˜1.5 wt. %) are also plotted; these points fall on a line roughly parallel to the low-carbon sample line. Presumably, conductivity data for samples with intermediate carbon contents would fall on other parallels between these two lines, provided that the details of coverage were similar and the other structural characteristics of the carbons were not significantly different than for these two sets of samples. The dotted tie lines show that an sp²/sp³ ratio close to 0.45 (i.e., requiring more than double the sp² character) is needed for ˜0.7 wt. % C carbon composites to achieve conductivities (and, by inference, electrochemical performances) similar to that of LiFePO₄ composites with ˜1.5 wt. % carbon in them.

According to an embodiment of the invention, a method for forming a structured carbon film on particles includes providing precursors for cathode material. The precursors include one or more Li sources, one or more metal sources, and an anion source. Cathode materials include any materials of interest for use in Li ion batteries, such as phosphates, sulfates, silicates, and oxides. When the cathode materials are heated in the presence of carbon, reduction of oxides can occur. It is useful to try to avoid reduction of oxides during processing. Precursors for cathode materials include Li sources, such as Li nitrates and acetates, metal sources, such as nitrates, acetates and oxylates of Fe, Mn, Co, Ni etc. or combinations of these, anion sources, such as nitrates, acetates, oxides phosphates, and oxylates.

The precursors are mixed with pyromellitic acid and, optionally, a graphitization catalyst and the composite mixture is fired in an inert atmosphere between about 500° C. and 700° C.

In another embodiment of the invention a method for forming a structured carbon film on particles includes providing substrate particles, milling the substrate particles with pyromellitic acid and, optionally, a graphitization catalyst and firing the composite powder in an inert atmosphere between about 500° C. and 700° C. In one embodiment, the pyromellitic acid comprises between approximately 1 and 10 wt % of the composite powder. The graphitization catalyst can be iron-based; it can be any of ferrocenecarboxylic acid, ferrocene, and iron nitrate. In one embodiment, wherein the graphitization catalyst comprises between approximately 0.001 and 5 wt % of the composite powder. In another embodiment, the graphitization catalyst comprises between approximately 2 and 10 wt % of the composite powder. In yet another embodiment, the graphitization catalyst comprises between approximately 4 and 6 wt % of the composite powder. In one arrangement, the firing is done at approximately 600° C.

In another embodiment of the invention, a method of forming a composite electrode, includes providing active electrode material particles, milling the active electrode material particles with pyromellitic acid and ferrocene or iron nitrate to produce a composite powder, firing the composite powder between 500° C. and 700° C., thus forming a carbon-coated electrode powder, and applying the composite powder to a current collector. The active electrode material particles can be any of LiFePO4, LiMnPO4, LiCoPO4, LiNiPO4, and combinations thereof. In another arrangement, the active electrode materials can be any of LiNi⅓Co⅓Mn⅓O2, LiCoO2, LiNiO2, LiNi0.8Cu0.2O2, LiNi0.8Cu0.15A10.05O2, and combinations thereof.

In another embodiment of the invention, a material composition includes substrate particles and a carbon coating on the particles, wherein, the carbon coating has a structure with an sp²/sp³ ratio greater than about 0.12, and wherein the overall composition contains no more than 10 wt % carbon. In some arrangements, the carbon coating has a structure with a D/G ratio less than about 1.19. In one embodiment the overall composition contains no more than 5 wt % carbon. In another embodiment, the overall composition contains no more than 2 wt % carbon. The substrate particles can be phosphates, sulfates, silicates, and oxides. In one embodiment, the substrate particles comprise LiFePO4.

Further experimental details can be found in the Journal of the Electrochemical Society, 154 (5) A389-A395 (2007), “Factors Influencing the Quality of Carbon Coatings on LiFePO4”, which is included by reference herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A method for forming a structured carbon film on particles, comprising the steps of:
providing precursors for cathode material,
mixing the precursors with pyromellitic acid and a graphitization catalyst derivative to produce a composite mixture; and
firing the composite mixture in an inert atmosphere between about 500° C. and 700° C.

2. The method of claim 1 wherein precursors comprise one or more Li sources, one or more metal sources, and an anion source.

3. A method for forming a structured carbon film on particles, comprising the steps of:
providing substrate particles;
milling the substrate particles with pyromellitic acid and said graphitization catalyst to produce a composite powder; and
firing the composite powder in an inert atmosphere between about 500° C. and 700° C.

4. The method of claim 3 wherein the pyromellitic acid comprises between approximately 1 and 10 wt % of the composite powder.

5. The method of claim 3 wherein the said graphitization catalyst is iron based.

6. The method of claim 3 wherein the graphitization catalyst is selected from the group comprising ferrocene, a ferrocene derivative, and iron nitrate.

7. The method of claim 6 wherein the ferrocene derivative is ferrocenecarboxylic acid.

8. The method of claim 3 wherein the graphitization catalyst comprises between approximately 0.001 and 5 wt % of the composite powder.

9. The method of claim 3 wherein the graphitization catalyst comprises between approximately 2 and 10 wt % of the composite powder.

10. The method of claim 3 wherein the graphitization catalyst comprises between approximately 4 and 6 wt % of the composite powder.

11. The method of claim 3 wherein the firing is done at approximately 600° C.

12. A method of forming a composite electrode, comprising the steps of:
providing active electrode material particles;
milling the active electrode material particles with pyromellitic acid and ferrocene, ferrocenecarboxylic acid, or iron nitrate to produce a composite powder;
firing the composite powder between 500° C. and 700° C., thus forming a carbon-coated electrode powder;
applying the composite powder to a current collector.

13. The method of claim 11 wherein the active electrode material particles are selected from the group consisting of LiFePO₄, LiMiPO₄, LiCoPO₄, LiNiPO₄, and combinations thereof.

14. The method of claim 11 wherein the active electrode material particles are selected from the group consisting of LiNi_{1/3}Co_{1/3}Mn_{1/3}O₂, LiCoO₂, LiNiO₂, LiNi_{0.8}Co_{0.2}O₂, LiNi_{0.8}Co_{0.15}Al_{0.05}O₂, and combinations thereof.

15. A material composition comprising:
substrate particles; and
a carbon coating on the particles;
wherein, the carbon coating has a structure with an sp²/sp³ ratio greater than about 0.12;
and wherein the overall composition contains no more than 10 wt % carbon.

16. The composition of claim 14 wherein the carbon coating has a structure with a D/G ratio less than about 1.19.

17. The composition of claim 14 wherein overall composition contains no more than 5 wt % carbon.

18. The composition of claim 14 wherein overall composition contains no more than 2 wt % carbon.

19. The composition of claim 14 wherein the substrate particles are selected from the group consisting of phosphates, sulfates, silicates, and oxides.

20. The composition of claim 14 wherein the substrate particles comprise LiFePO₄.
